(19) United States
(12) Patent Application Publication
(10) Pub. No.: US 2026/0323560 A1
(43) Pub. Date: Oct. 15, 2026

(54) UE BEHAVIOR WHEN CONNECTION FOR EMERGENCY BEARER SERVICES FAILED DUE TO NETWORK AUTHENTICATION FAILURE

(71) Applicant: MediaTek Singapore Pte. Ltd., Singapore (SG)

(72) Inventors: Puneet ., Bengaluru (IN); Marko NIEMI, Oulu (FI)

(73) Assignee: MediaTek Singapore Pte. Ltd., Singapore (SG)

(21) Appl. No.: 19/474,032

(22) PCT Filed: Sep. 29, 2024
(86) PCT No.: PCT/CN2024/122193

§ 371 Date: Oct. 9, 2025

(30) Foreign Application Priority Data
Oct. 3, 2023 (IN) 202321066166
Oct. 3, 2023 (IN) 202321066167

(51) Int. Cl. H04W 60/00; H04W 4/50; H04W 4/90; H04W 48/18; H04W 60/02; H04W 60/06; H04W 84/04

(52) U.S. Cl. CPC H04W 60/001; H04W 4/50; H04W 4/90; H04W 48/18; H04W 60/02; H04W 60/06; H04W 84/042

(57) ABSTRACT

In an aspect of the disclosure, a method, a computer-readable medium, and an apparatus are provided. The apparatus may be a UE. The UE receives an Authentication Reject message from a network during an attempt to establish an emergency service through a first procedure. The UE performs generic actions for authentication rejection. The UE informs upper layers of a failure of the first procedure. Alternatively, the UE attempts to perform a second procedure.

### CROSS-REFERENCE TO RELATED APPLICATION(S)

This application claims priorities of Indian Patent Application Serial No. 202321066166, entitled “A METHOD TO DEFINE UE BEHAVIOR WHEN EMERGENCY SERVICES FALLBACK IS FAILED DUE TO AUTHENTICATION FAILURE” and filed on Oct. 3, 2023, and Indian Patent Application Serial No. 202321066167, entitled “A METHOD TO DEFINE UE BEHAVIOR WHEN EMERGENCY SERVICES FALLBACK IS FAILED DUE TO AUTHENTICATION FAILURE” and filed on Oct. 3, 2023; both of which are expressly incorporated by reference herein in their entirety.

### BACKGROUND

### Field

The present disclosure relates generally to communication systems, and more particularly, to techniques of handling authentication failures during emergency services procedures in wireless communication networks.

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. The UE receives an AUTHENTICATION REJECT message from a network during an attempt to establish an emergency service through a first procedure. The UE performs generic actions for authentication rejection. The UE informs upper layers of a failure of the first procedure. Alternatively, the UE attempts to perform a second procedure.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating a scenario where a UE establishes an emergency PDU session with a visited public land mobile network (PLMN) when its home network becomes unavailable.

FIG. 8 is a diagram illustrating a scenario where a UE establishes an emergency Packet Data Network (PDN) connection with a visited PLMN when its home network becomes unavailable.

FIG. 9 is a flow chart of a method for handling authentication failures during emergency services procedures.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

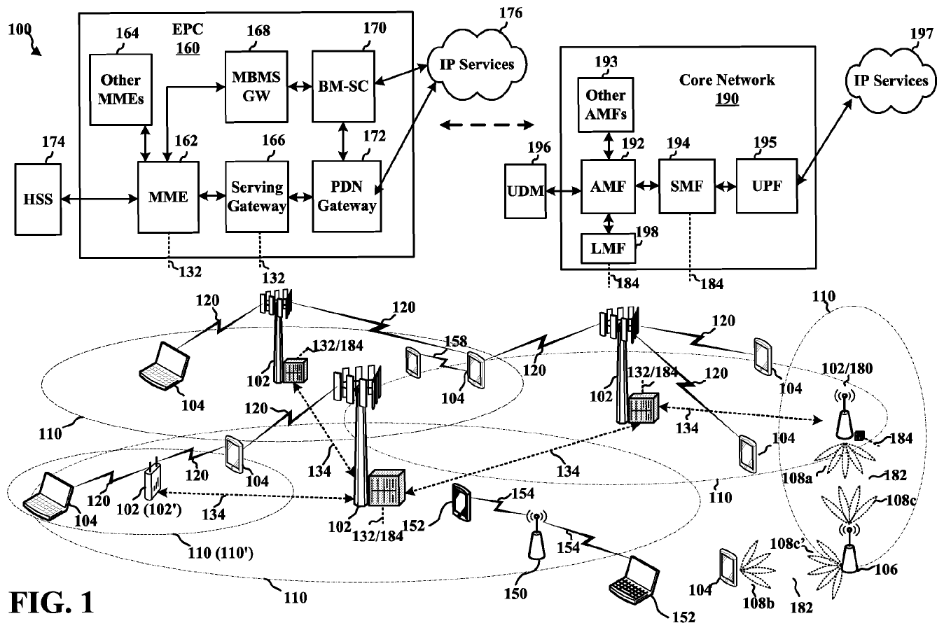

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHZ unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mm W or near mm W frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHZ and 30 GHz, also referred to as centimeter wave. Communications using the mmW/near mmW radio frequency band (e.g., 3 GHZ-300 GHz) has extremely high path loss and a short range. The mm W base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

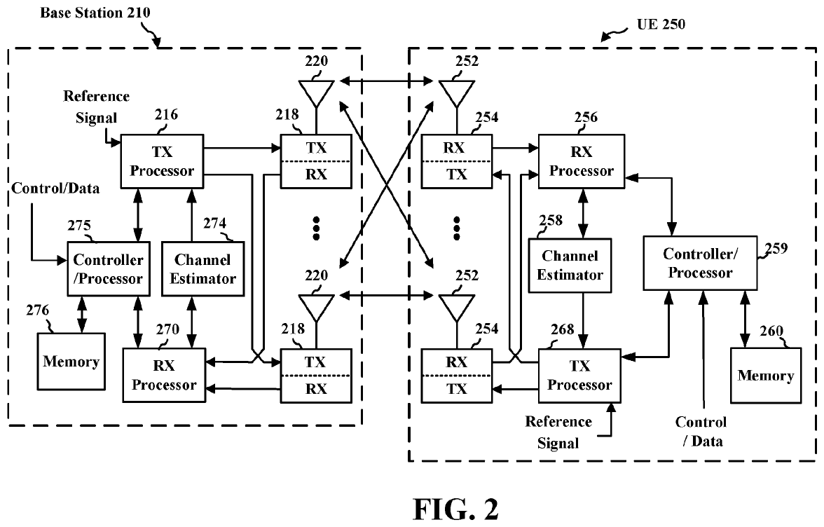

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification), RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

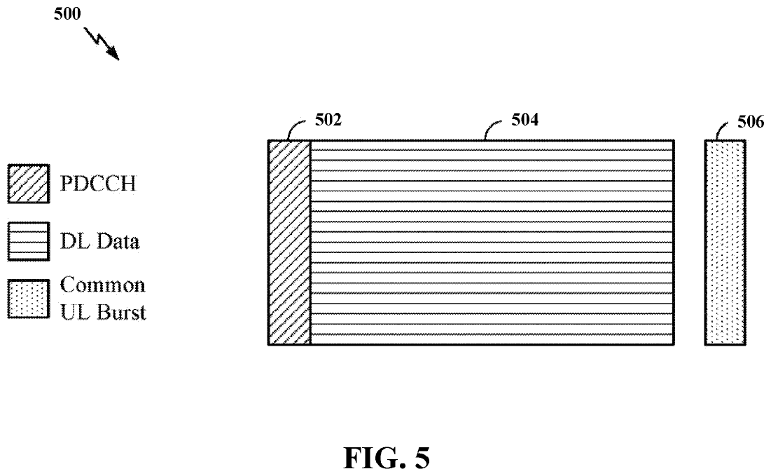

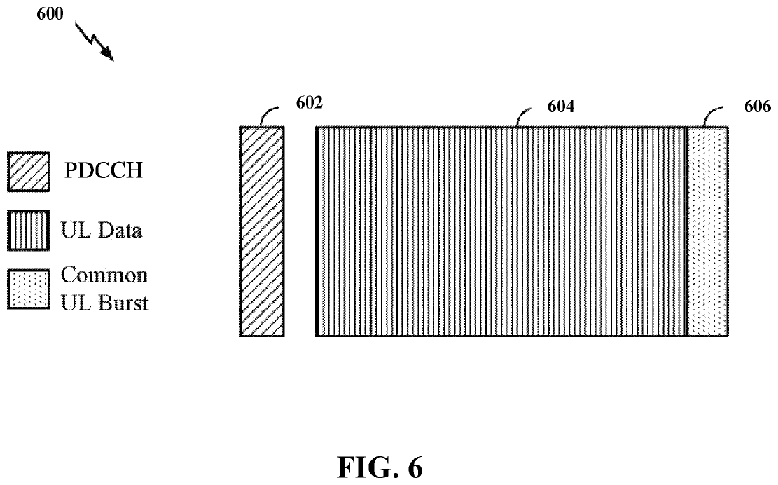

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

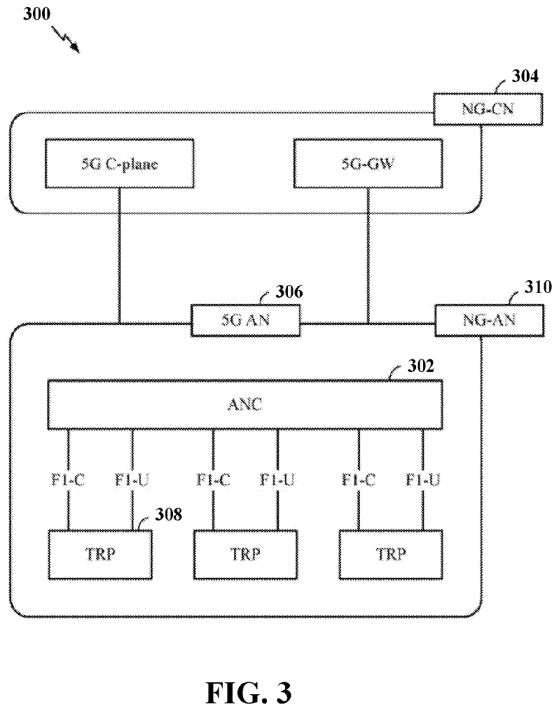

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

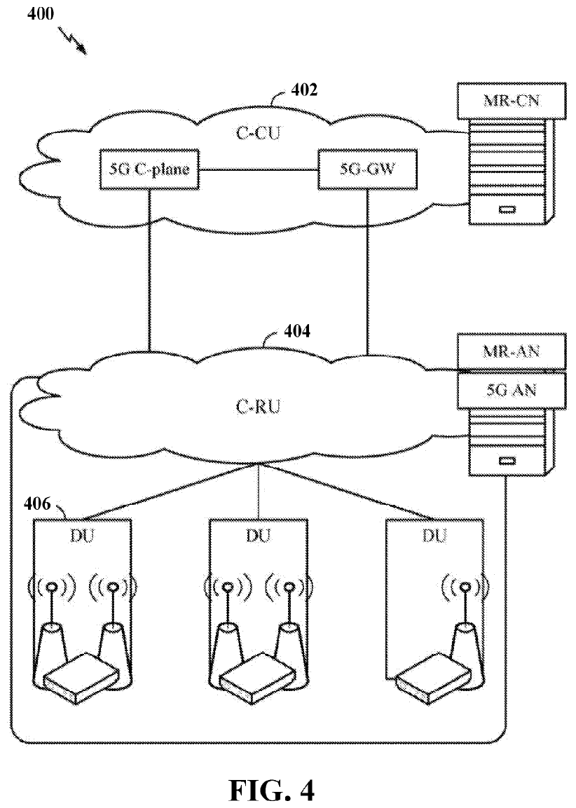

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

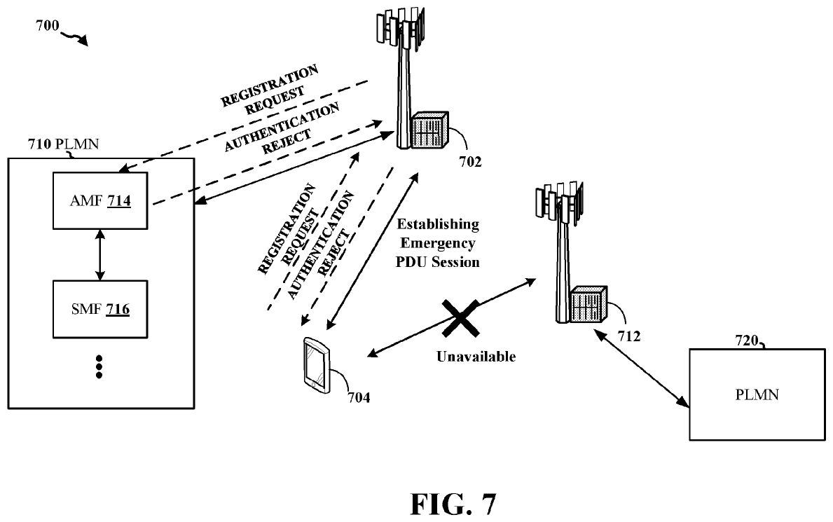

FIG. 7 is a diagram 700 illustrating a scenario where a user equipment (UE) 704 establishes an emergency PDU session with a visited public land mobile network (PLMN) 710 when its home network becomes unavailable. In this example, the UE 704 is initially camped on a cell provided by a base station 712 of a PLMN 720, which may be the UE's home network.

In an emergency situation, the base station 712 and the PLMN 720 become unavailable, potentially due to network failure or coverage issues. The UE 704 finds itself under the coverage of a cell provided by a base station 702 of the PLMN 710, which serves as a visited network in this scenario. The PLMN 710 includes, among other components, an Access and Mobility Management Function (AMF) 714 and a Session Management Function (SMF) 716.

When the UE 704 detects the emergency situation and the unavailability of its current network, it initiates the process to establish an emergency PDU session with the PLMN 710. The UE 704 first performs a registration procedure with the AMF 714 through the base station 702. This registration procedure includes the UE 704 sending a Registration Request message to the AMF 714, indicating its need for emergency services.

Upon receiving the Registration Request, the AMF 714 may initiate an authentication procedure with the UE 704. However, given the emergency nature of the request, the network may choose to proceed with limited authentication or skip authentication altogether, as specified in 3GPP standards for emergency services.

After the registration process, the UE 704 initiates a PDU session establishment procedure for emergency services. It sends a PDU Session Establishment Request message to the AMF 714, which forwards the request to the SMF 716. The SMF 716 then allocates network resources and configures the necessary parameters for the emergency PDU session.

If the PDU session establishment is successful, the SMF 716 sends a response back to the AMF 714, which then informs the UE 704 of the successful establishment of the emergency PDU session. At this point, the UE 704 can begin using the emergency services provided by the PLMN 710.

During this process, various authentication failures may occur. Accordingly, the AMF 714 may send an AUTHENTICATION REJECT message to the UE 704 during the authentication procedure for various reasons. In one situation, the authentication response from the UE 704 may not be valid. For example, if the UE 704 fails to provide the correct authentication parameters or if there is a mismatch in the security context between the UE 704 and the network, the AMF 714 may determine that the authentication procedure cannot be completed successfully. Therefore, the AMF 714 sends the AUTHENTICATION REJECT message.

In another situation. the network may detect potential security threats or suspicious behavior from the UE 704. For example, if the AMF 714 suspects that the UE 704 is attempting to use fraudulent credentials or if there are signs of a replay attack, it may choose to reject the authentication to protect the network's integrity.

Upon receiving the authentication reject message, the ue 704 must follow a specific set of actions to handle the authentication failure while still attempting to access emergency services. First, the UE 704 performs generic actions for authentication rejection as defined by the network protocols. These actions typically involve updating the UE's internal state and clearing certain security parameters.

These generic actions may be performed to maintain network security and integrity. Upon receiving the AUTHENTICATION REJECT message, the UE 704 first verifies the integrity of the message. If the message passes the integrity check, the UE 704 proceeds with a series of actions to update its status and clear sensitive information.

The UE 704 sets its update status to 5U3 ROAMING NOT ALLOWED, indicating that it is not permitted to roam on the current network. It then deletes several key pieces of information from its memory, including the stored 5G-GUTI (Globally Unique Temporary Identifier), the TAI (Tracking Area Identity) list, the last visited registered TAI, and the ngKSI (Next Generation Key Set Identifier). This deletion of information is a security measure to prevent unauthorized access to the network using potentially compromised credentials.

In case of PLMN, the UE 704 considers its USIM (Universal Subscriber Identity Module) invalid. This invalidation remains in effect until the UE 704 is switched off or the UICC (Universal Integrated Circuit Card) containing the USIM is removed. This measure prevents further attempts to authenticate using the potentially compromised USIM.

For SNPNs (Stand-alone Non-Public Networks), the UE 704 follows a slightly different procedure. If the UE 704 is not registered for onboarding services in the SNPN and does not support certain advanced features (such as access to an SNPN using credentials from a credentials holder or equivalent SNPNs), it marks the entry in its “list of subscriber data” corresponding to the current SNPN as invalid. This invalidation persists until the UE 704 is switched off or the entry is updated. Additionally, the UE 704 considers the USIM invalid for the current SNPN until the UE 704 is switched off or the UICC containing the USIM is removed.

After performing the generic actions, the UE 704 has several options to pursue. One option is for the UE 704 to de-register locally from the current network without informing the network, and then attempt an initial registration specifically for emergency services. This approach allows the UE 704 to start fresh with a new registration attempt focused solely on obtaining emergency services.

Alternatively, the UE 704 may attempt to select an E-UTRA cell connected to either the Evolved Packet Core (EPC) or the 5G Core Network (5GCN). This option enables the UE 704 to try accessing emergency services through a different radio access technology, potentially increasing the chances of successful connection.

In all cases, regardless of the specific action taken, the UE 704 informs its upper layers about the authentication failure. This notification allows the upper layers of the UE 704 to invoke implementation-specific mechanisms for handling the emergency situation. The upper layers, upon receiving this information, can initiate alternative procedures to ensure that the emergency call is attempted through different means. One such alternative is to attempt the emergency call over a different IP Connectivity Access Network (IP-CAN). For instance, the upper layers might decide to try the emergency call over a Wi-Fi network if available.

Another option that the upper layers might consider is attempting the emergency call over the Circuit Switched (CS) domain. This is particularly relevant if the UE 704 supports legacy radio access technologies like GSM or UMTS, which still utilize CS domains for voice calls.

Further, these actions apply not only when the UE 704 is attempting to register with a new PLMN 710 after its home network PLMN 720 becomes unavailable, but also when the UE 704 is in the same selected PLMN where the last service request procedure or mobility registration update procedure was attempted. The UE 704 has multiple pathways to attempt establishing an emergency PDU session, even in the face of authentication challenges.

In one example, the UE 704 performs an initial registration with 5GS registration type IE set to “initial registration” and for sending a PDU SESSION ESTABLISHMENT REQUEST message with request type set to “initial emergency request”. In particular, the UE 704 may attempt to register with the 5GCN (5G Core Network), e.g., the AMF 714, for the first time. This may occur, when the UE 704 is powered on or when it moves into a new tracking area. The initial registration process establishes a basic connection between the UE 704 and the network, allowing the UE 704 to access network services. A request type set to “initial emergency request.” This indicates that the UE 704 requires immediate access to emergency services, such as making an emergency call. The network may prioritize such requests and potentially bypass certain authentication steps to expedite the process.

The initial registration request for initiating an emergency PDU session may fail due to receiving an AUTHENTICATION REJECT message, as the network may not be able to authenticate the UE 704. Accordingly, the UE 704 performs the generic actions described supra.

Following the generic actions, if the UE 704 is still in the same selected PLMN (Public Land Mobile Network) where the last initial registration request was attempted, it has two primary options. It can inform the upper layers, which are the software layers responsible for applications and services, about the failure of the registration procedure. This allows the upper layers to potentially trigger alternative emergency call attempts using different mechanisms, such as those described in 3GPP TS 24.229.

Alternatively, the UE 704 can attempt another initial registration specifically for emergency services. This approach focuses on establishing a connection solely for the purpose of accessing emergency services, potentially bypassing non-essential network functionalities.

In another example, a UE 704 needs to update its registration with the network while also requesting access to emergency services. This may occur in situations where the UE 704 has moved to a new tracking area or needs to perform a periodic update of its registration, all while requiring immediate access to emergency services.

In the example shown in FIG. 7, the UE 704 may initiate this procedure when it moves from the coverage area of the base station 712 in the PLMN 720 to the coverage area of the base station 702 in the PLMN 710. The UE 704 sends a mobility and periodic registration update request to the AMF 714 through the base station 702, indicating its need for emergency services.

However, there are instances where this request cannot be accepted by the network. One such instance is when the request fails due to the UE 704 receiving an AUTHENTICATION REJECT message from the AMF 714. This situation can occur if the AMF 714 is unable to authenticate the UE 704, possibly due to security concerns or issues with the UE's credentials.

Upon receiving the AUTHENTICATION REJECT message, the UE 704 may perform generic actions described supra. These actions typically involve updating the UE's internal state and clearing certain security parameters to maintain network integrity.

After completing these initial procedures, if the UE 704 finds itself still in the same PLMN 710 where it last attempted the mobility and periodic registration update request, it has two options for proceeding:

The first option is for the UE 704 to inform its upper layers about the failure of the procedure. This notification allows the upper layers of the UE 704 to invoke implementation-specific mechanisms for handling the emergency situation. This can result in the upper layers requesting alternative procedures, such as those specified in 3GPP TS 24.229. These procedures may involve attempting the emergency call over a different IP Connectivity Access Network (IP-CAN), such as a Wi-Fi network if available.

The second option is for the UE 704 to perform a local de-registration, if it hasn't already done so, and then attempt an initial registration specifically for emergency services. This approach allows the UE 704 to start fresh with a new registration attempt focused solely on obtaining emergency services. By performing a local de-registration, the UE 704 clears its current registration state without informing the network, potentially avoiding any lingering issues from the failed authentication.

In yet another example, the UE 704 may request emergency services from the network. This may occur in scenarios where the UE 704 needs to establish an emergency PDU session with a visited PLMN 710, such as when its home network PLMN 720 becomes unavailable.

When the UE 704 initiates a service request for an emergency PDU session, it sends a message to the AMF 714 through the base station 702. However, there are situations where this request cannot be accepted by the network. One such situation occurs when the service request fails due to the UE 704 receiving an AUTHENTICATION REJECT message from the AMF 714. This can happen if the AMF 714 is unable to authenticate the UE 704, possibly due to security concerns or issues with the UE's credentials.

Upon receiving the AUTHENTICATION REJECT message, the UE 704 performs generic actions as described supra. These procedures typically involve updating the UE's internal state and clearing certain security parameters to maintain network integrity.

After completing the generic actions, if the UE 704 finds itself still in the same PLMN 710 where it last attempted the service request, it has two options for proceeding. The first option is for the UE 704 to inform its upper layers about the failure of the procedure. This notification allows the upper layers of the UE 704 to invoke implementation-specific mechanisms for handling the emergency situation. This can result in the upper layers requesting another emergency call attempt using domain selection as specified in 3GPP TS 23.167. This may involve attempting the emergency call over a different radio access technology or even a different type of network, such as a Wi-Fi network if available.

The second option available to the UE 704 is to perform a local de-registration, if it has not already done so, and then attempt an initial registration specifically for emergency services. This approach allows the UE 704 to start fresh with a new registration attempt focused solely on obtaining emergency services. By performing a local de-registration, the UE 704 clears its current registration state without informing the network, potentially avoiding any lingering issues from the failed authentication.

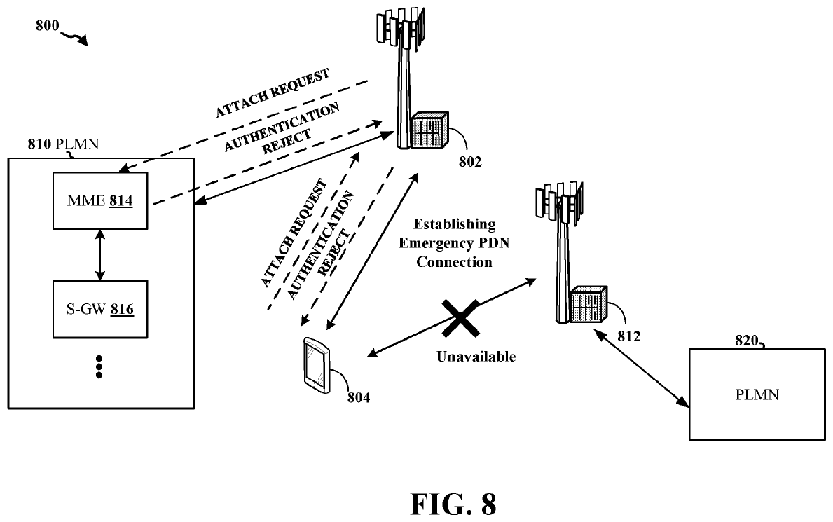

FIG. 8 is a diagram 800 illustrating a scenario where a user equipment (UE) 804 establishes an emergency PDN connection with a visited public land mobile network (PLMN) 810 when its home network becomes unavailable. This scenario is similar to that depicted in FIG. 7, but focuses on the 4G EPS (Evolved Packet System) context rather than the 5G context.

In this example, the UE 804 is initially camped on a cell provided by a base station 812 of a PLMN 820, which may be the UE's home network. During an emergency situation, the base station 812 and the PLMN 820 become unavailable, potentially due to network failure or coverage issues. The UE 804 then finds itself under the coverage of a cell provided by a base station 802 of the PLMN 810, which serves as a visited network in this scenario. The PLMN 810 includes, among other components, a Mobility Management Entity (MME) 814 and a Serving Gateway (S-GW) 816.

When the UE 804 detects the emergency situation and the unavailability of its current network, it initiates the process to establish an emergency PDN connection with the PLMN 810. The UE 804 first performs an attach procedure with the MME 814 through the base station 802. This attach procedure includes the UE 804 sending an Attach Request message to the MME 814, indicating its need for emergency services.

Upon receiving the Attach Request, the MME 814 may initiate an authentication procedure with the UE 804. However, given the emergency nature of the request, the network may choose to proceed with limited authentication or skip authentication altogether, as specified in 3GPP standards for emergency services.

After the attach process, the UE 804 initiates a PDN connectivity procedure for emergency bearer services. It sends a PDN Connectivity Request message to the MME 814, which forwards the request to the S-GW 816. The S-GW 816 then allocates network resources and configures the necessary parameters for the emergency PDN connection.

If the PDN connectivity establishment is successful, the S-GW 816 sends a response back to the MME 814, which then informs the UE 804 of the successful establishment of the emergency PDN connection. At this point, the UE 804 can begin using the emergency services provided by the PLMN 810.

During this process, various authentication failures may occur. The MME 814 may send an AUTHENTICATION REJECT message to the UE 804 during the authentication procedure for various reasons, similar to the 5G scenario described in FIG. 7. This can happen if the authentication response from the UE 804 is not valid, or if the network detects potential security threats or suspicious behavior from the UE 804.

Upon receiving the AUTHENTICATION REJECT message, the UE 804 follows a specific set of actions to handle the authentication failure while still attempting to access emergency services. First, the UE 804 performs generic actions for authentication rejection as defined by the network protocols. These actions typically involve updating the UE's internal state and clearing certain security parameters.

After performing the generic actions, the UE 804 has several options to pursue. One option is for the UE 804 to detach locally from the current network without informing the network, and then attempt an emergency attach procedure. This approach allows the UE 804 to start fresh with a new attach attempt focused solely on obtaining emergency services.

Alternatively, the UE 804 may attempt to select a GERAN (GSM EDGE Radio Access Network) or UTRAN (UMTS Terrestrial Radio Access Network) cell. This option enables the UE 804 to try accessing emergency services through a different radio access technology, potentially increasing the chances of successful connection.

In all cases, regardless of the specific action taken, the UE 804 informs its upper layers about the authentication failure. This notification allows the upper layers of the UE 804 to invoke implementation-specific mechanisms for handling the emergency situation. For instance, the upper layers might decide to attempt the emergency call over a different IP Connectivity Access Network (IP-CAN), such as a Wi-Fi network if available.

These actions apply not only when the UE 804 is attempting to attach to a new PLMN 810 after its home network PLMN 820 becomes unavailable, but also when the UE 804 is in the same selected PLMN where the last service request procedure, EMM ATTACH procedure, or EMM Tracking Area Updating procedure was attempted. The UE 804 has multiple pathways to attempt establishing an emergency PDN connection, even in the face of authentication challenges.

In the context of EMM procedures, the UE 804 may encounter authentication rejection during an EMM ATTACH procedure, EMM Tracking Area Updating procedure, or service request procedure initiated for emergency services. In each of these cases, if the UE 804 receives an AUTHENTICATION REJECT message, it follows a similar set of actions to those described above.

For example, during an EMM ATTACH procedure for emergency bearer services, if the UE 804 receives an AUTHENTICATION REJECT message, it first performs the generic actions for authentication rejection. Then, if the UE 804 is still in the same selected PLMN where the last attach request was attempted, it can either inform the upper layers of the failure or attempt an EPS attach specifically for emergency bearer services.

Similarly, during an EMM Tracking Area Updating procedure or a service request procedure for emergency bearer services, if authentication is rejected, the UE 804 follows the same general pattern: perform generic actions, then either inform upper layers or attempt a new emergency-specific procedure.

In all these scenarios, the upper layers of the UE 804, upon being informed of the failure, may initiate alternative procedures to attempt the emergency call through different means. This could include attempting the emergency call over a different IP-CAN or even over the Circuit Switched (CS) domain if the UE 804 supports legacy radio access technologies.

These procedures provide the UE 804 with multiple options to establish emergency services.

In one example, the UE 804 may need to establish an emergency connection when its home network becomes unavailable. The UE 804 may send attach request for initiating a PDN connection for emergency bearer services. The attach request with attach type not set to “EPS emergency attach” for initiating a PDN connection for emergency bearer services may fail due to receiving the AUTHENTICATION REJECT message. In response, the UE 804 follows a set of predefined actions to handle this rejection while still attempting to access emergency services. More specifically, after performing the generic actions described in clause 5.4.2.5 of 3GPP TS 24.301, if the UE 804 remains in the same PLMN 810 where the last attach request was attempted, the UE 804 has two main options if it remains in the same PLMN where the last attach request was attempted.

The first option is for the UE 804 to inform its upper layers about the failure of the procedure. This notification allows the upper layers to initiate alternative methods for establishing emergency communications. For instance, the upper layers may request the establishment of a CS (Circuit Switched) emergency call, provided this hasn't been attempted already in the CS domain. Alternatively, the upper layers may invoke other implementation-specific mechanisms. One such mechanism, as specified in 3GPP TS 24.229, could result in the emergency call being attempted over a different IP Connectivity Access Network (IP-CAN).

The second option available to the UE 804 is to attempt an EPS attach specifically for emergency bearer services. This attempt includes sending a PDN CONNECTIVITY REQUEST message, indicating the UE's continued effort to establish an emergency connection despite the initial authentication failure.

By allowing the UE 804 to either inform upper layers or directly attempt an emergency-specific attach, the procedure aims to maximize the chances of establishing emergency communications. The option to attempt the emergency call over different networks or technologies (such as CS domain or alternative IP-CANs) further enhances this approach.

In another example, as shown in FIG. 8, the UE 804 may be performing a tracking area update procedure to maintain its connection with the network while also attempting to initiate a PDN connection for emergency bearer services. This scenario can arise when the UE 804 moves from one tracking area to another within the PLMN 810 and simultaneously requires access to emergency services.

During this tracking area updating procedure, the UE 804 may encounter authentication challenges. If the tracking area updating request for initiating a PDN connection for emergency bearer services fails due to receiving an AUTHENTICATION REJECT message from the MME 814, the UE 804 must take specific actions to handle this authentication failure while still attempting to access emergency services.

As shown in FIG. 8, when the UE 804 attempts to initiate a PDN connection for emergency bearer services, it may encounter authentication failures. Specifically, if the UE 804 receives an AUTHENTICATION REJECT message from the MME 814 during an attach procedure, it must follow a set of predefined actions to handle this rejection while still attempting to access emergency services.

After performing the generic actions described in clause 5.4.2.5 of 3GPP TS 24.301, if the UE 804 is still within the same selected PLMN 810 where it last attempted the tracking area updating request, the UE 804 has two main options if it remains in the same PLMN where the last attach request was attempted.

The first option is for the UE 804 to inform its upper layers about the failure of the procedure. This notification allows the upper layers to initiate alternative methods for establishing emergency communications. For instance, the upper layers may request the establishment of a CS (Circuit Switched) emergency call, provided this hasn't been attempted already in the CS domain. Alternatively, the upper layers may invoke other implementation-specific mechanisms. One such mechanism, as specified in 3GPP TS 24.229, could result in the emergency call being attempted over a different IP Connectivity Access Network (IP-CAN).

The second option available to the UE 804 is to detach locally from the current network, if it has not already done so, and then attempt an EPS attach specifically for emergency bearer services. This approach allows the UE 804 to start fresh with a new attach attempt focused solely on obtaining emergency services.

By allowing the UE 804 to either inform upper layers or directly attempt an emergency-specific attach, the procedure aims to maximize the chances of establishing emergency communications. The option to attempt the emergency call over different networks or technologies (such as CS domain or alternative IP-CANs) further enhances this approach.

In yet another example, in FIG. 8, the UE 804 may initiate a service request procedure through the base station 802 to the MME 814 of the PLMN 810. The procedure aims to establish a PDN connection specifically for emergency bearer services. However, during this process, the UE 804 may encounter authentication challenges.

If the service request fails due to the UE 804 receiving an AUTHENTICATION REJECT message from the MME 814, the UE 804 follows a specific set of actions. First, the UE 804 performs the procedures described in clause 5.4.2.5 of 3GPP TS 24.301. These procedures typically involve updating the UE's internal state and clearing certain security parameters to maintain network integrity.

After completing these initial procedures, if the UE 804 finds itself still in the same PLMN 810 where it last attempted the service request, it has two options for proceeding. The first option is for the UE 804 to inform its upper layers about the failure of the procedure. This notification is significant as it allows the upper layers of the UE 804 to invoke implementation-specific mechanisms for handling the emergency situation. For instance, the upper layers may request the establishment of a Circuit Switched (CS) emergency call, provided this hasn't been attempted already in the CS domain. Alternatively, the upper layers may initiate other procedures, such as those specified in 3GPP TS 24.229, which may result in the emergency call being attempted over a different IP Connectivity Access Network (IP-CAN), such as a Wi-Fi network if available.

The second option available to the UE 804 is to perform a local detach, if it has not already done so, and then attempt an EPS attach specifically for emergency bearer services. This approach allows the UE 804 to start fresh with a new attach attempt focused solely on obtaining emergency services. By performing a local detach, the UE 804 clears its current attachment state without informing the network, potentially avoiding any lingering issues from the failed authentication.

These procedures provide the UE 804 with multiple pathways to attempt establishing an emergency PDN connection.

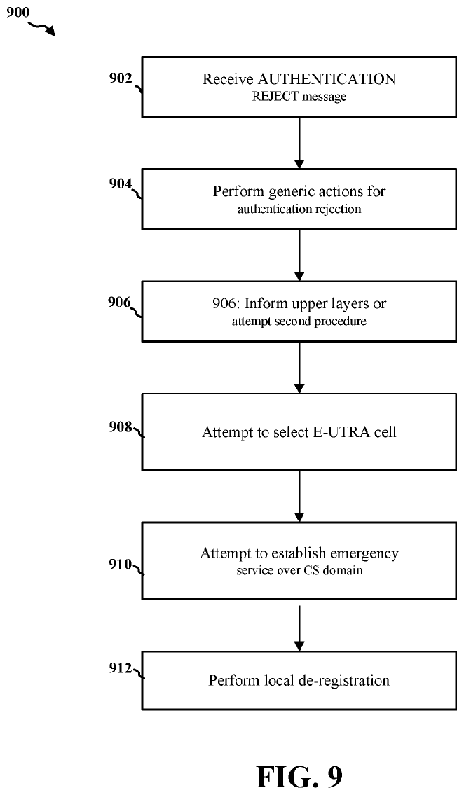

FIG. 9 is a flow chart 900 of a method for handling authentication failures during emergency services procedures. The method may be performed by a UE (e.g., the UE 704 or 804). In operation 902, the UE receives an AUTHENTICATION REJECT message from a network during an attempt to establish an emergency service through a first procedure. In operation 904, the UE performs generic actions for authentication rejection. The generic actions for authentication rejection may include setting an update status to indicate roaming is not allowed, deleting stored network identifiers and security parameters, and considering a Universal Subscriber Identity Module (USIM) invalid.

In operation 906, the UE either informs upper layers of a failure of the first procedure or attempts to perform a second procedure. In certain configurations, informing the upper layers results in the upper layers requesting implementation specific mechanisms for attempting the emergency service through another IP Connectivity Access Network (IP-CAN). In certain configurations, informing the upper layers of the failure allows the upper layers to request establishment of a CS emergency call or other implementation-specific mechanisms.

In certain configurations, the first procedure includes a registration procedure for initiating an emergency PDU session or a service request procedure for initiating an emergency PDU session, and the second procedure includes an initial registration for emergency services. The registration procedure may include an initial registration or a mobility and periodic registration update.

In certain configurations, the first procedure includes an attach procedure for initiating a Packet Data Network (PDN) connection for emergency bearer services, a tracking area updating procedure for initiating a PDN connection for emergency bearer services, or a service request procedure for initiating a PDN connection for emergency bearer services, and the second procedure includes an attach procedure for emergency bearer services.

In operation 908, the UE may attempt to select an E-UTRA cell connected to an Evolved Packet Core (EPC) or a 5G Core Network (5GCN). In operation 910, the UE may attempt to establish the emergency service over a Circuit Switched (CS) domain if the UE supports legacy radio access technologies.

In certain configurations, the attempt to establish the emergency service is performed when the UE's home network becomes unavailable. The AUTHENTICATION REJECT message may be received during an attempt to establish the emergency service with a visited Public Land Mobile Network (PLMN) after the UE's home network becomes unavailable.

In certain configurations, the second procedure is performed when the UE remains in a same selected Public Land Mobile Network (PLMN) where a last procedure was attempted. In operation 912, the UE may perform a local de-registration from a current network without informing the network before attempting an initial registration specifically for emergency services.

In certain configurations, the first procedure includes a service request procedure, and the second procedure includes an initial registration for emergency services. In certain configurations, the first procedure includes a tracking area update procedure for initiating a PDN connection for emergency bearer services, and the second procedure includes an EPS attach specifically for emergency bearer services.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a User Equipment (UE), comprising:
receiving an AUTHENTICATION REJECT message from a network during an attempt to establish an emergency service through a first procedure;
performing generic actions for authentication rejection; and
informing upper layers of a failure of the first procedure or attempting to perform a second procedure.

2. The method of claim 1, wherein the first procedure comprises a registration procedure for initiating an emergency PDU session or a service request procedure for initiating an emergency PDU session, and the second procedure comprises an initial registration for emergency services.

3. The method of claim 2, wherein the registration procedure comprises an initial registration or a mobility and periodic registration update.

4. The method of claim 1, wherein the first procedure comprises an attach procedure for initiating a Packet Data Network (PDN) connection for emergency bearer services, a tracking area updating procedure for initiating a PDN connection for emergency bearer services, or a service request procedure for initiating a PDN connection for emergency bearer services, and the second procedure comprises an attach procedure for emergency bearer services.

5. The method of claim 1, wherein informing the upper layers results in the upper layers requesting implementation specific mechanisms for attempting the emergency service through another IP Connectivity Access Network (IP-CAN).

6. The method of claim 1, further comprising:
attempting to select an E-UTRA cell connected to an Evolved Packet Core (EPC) or a 5G Core Network (5GCN).

7. The method of claim 1, wherein the generic actions for authentication rejection comprise:
setting an update status to indicate roaming is not allowed;
deleting stored network identifiers and security parameters; and
considering a Universal Subscriber Identity Module (USIM) invalid.

8. The method of claim 1, wherein the attempt to establish the emergency service is performed when the UE's home network becomes unavailable.

9. The method of claim 1, wherein the first procedure comprises a service request procedure, and the second procedure comprises an initial registration for emergency services.

10. The method of claim 1, wherein the second procedure is performed when the UE remains in a same selected Public Land Mobile Network (PLMN) where a last procedure was attempted.

11. The method of claim 1, further comprising:
performing a local de-registration from a current network without informing the network before attempting an initial registration specifically for emergency services.

12. The method of claim 1, further comprising:
attempting to establish the emergency service over a Circuit Switched (CS) domain if the UE supports legacy radio access technologies.

13. The method of claim 1, wherein the first procedure comprises a tracking area update procedure for initiating a PDN connection for emergency bearer services, and the second procedure comprises an EPS attach specifically for emergency bearer services.

14. The method of claim 1, wherein informing the upper layers of the failure allows the upper layers to request establishment of a CS emergency call or other implementation-specific mechanisms.

15. The method of claim 1, wherein the AUTHENTICATION REJECT message is received during an attempt to establish the emergency service with a visited Public Land Mobile Network (PLMN) after the UE's home network becomes unavailable.

16. An apparatus for wireless communication, the apparatus being a user equipment (UE), comprising:
a memory; and
at least one processor coupled to the memory and configured to:
receive an AUTHENTICATION REJECT message from a network during an attempt to establish an emergency service through a first procedure;
perform generic actions for authentication rejection; and
inform upper layers of a failure of the first procedure or attempt to perform a second procedure.

17. The apparatus of claim 16, wherein the first procedure comprises a registration procedure for initiating an emergency PDU session or a service request procedure for initiating an emergency PDU session, and the second procedure comprises an initial registration for emergency services.

18. The apparatus of claim 17, wherein the registration procedure comprises an initial registration or a mobility and periodic registration update.

19. The apparatus of claim 16, wherein the first procedure comprises an attach procedure for initiating a Packet Data Network (PDN) connection for emergency bearer services, a tracking area updating procedure for initiating a PDN connection for emergency bearer services, or a service request procedure for initiating a PDN connection for emergency bearer services, and the second procedure comprises an attach procedure for emergency bearer services.

20. A computer-readable medium storing computer executable code for wireless communication of a user equipment (UE), comprising code to:
receive an AUTHENTICATION REJECT message from a network during an attempt to establish an emergency service through a first procedure;
perform generic actions for authentication rejection; and
inform upper layers of a failure of the first procedure or attempt to perform a second procedure.
